(19) United States
(12) Patent Application Publication
(10) Pub. No.: US 2013/0025998 A1
(43) Pub. Date: Jan. 31, 2013

(54) CLUTCH DEVICE AND CONTROL METHOD

(71) Applicants: Christoph Brenner, Steyr (AT); Hans Deinhofer, St. Peter i. d. Au (AT)

(72) Inventors: Christoph Brenner, Steyr (AT); Hans Deinhofer, St. Peter i. d. Au (AT)

(73) Assignee: ENGINEERING CENTER STEYR GMBH & CO KG, St. Valentin (AT)

(21) Appl. No.: 13/364,604

(22) Filed: Feb. 2, 2012

(30) Foreign Application Priority Data
Feb. 4, 2011 (DE) 10 2011 010 361.9

(51) Int. Cl. F16D 25/12

(52) U.S. Cl. 192/85.63

(57) ABSTRACT

A clutch device has a first clutch part and a second clutch part which can selectively be brought into engagement with one another with form fitting as well as a control unit which includes a disengagement unit and an actuator unit operable by means of a fluid pressure. A force disengaging the clutch parts can be generated by the disengagement unit and a force engaging the clutch parts can be generated by the actuator unit. The control device includes a pressure holding device to reduce a fluid pressure acting on the actuator unit in accordance with a predefined characteristic.

The present invention relates to a clutch device for a powertrain of a motor vehicle having a first clutch part and a second clutch part which can be selectively brought into engagement with one another with form fitting.

Clutch devices of this type are in particular used as an interlock clutch of a differential gear, for example in an axle differential or in a central differential of a motor vehicle.

Interlock clutches having rotating clutch parts which cooperate in a form-fitting manner have the advantage that they are able to transfer very high torques very reliably. Friction clutches having a similar performance capability are much larger and more expensive than clutch devices of the initially named kind. Form-fitted clutch devices, however, suffer from the disadvantage that they are more difficult to control—compared with friction clutches of similar performance capability. An engagement of such clutch devices generally requires that there is no speed of rotation difference or only a small speed of rotation difference between the two clutch parts. A sufficiently low torque transfer must be present for a disengagement. A high switching force to be applied can in particular be required on a disengagement since an axial friction force which counters a disengagement and which depends on, among other things, the amount of the torque instantaneously transferred by the clutch device acts between the components of the clutch parts mutually meshing in a form fitting manner.

EP 0 510 457 A1 discloses a clutch device of the above-named kind. It includes a clutch part arranged fixed to the axle, an axially movable clutch part and a compression spring by which a force disengaging the clutch parts is provided. This force is substantially as large as the axial friction force between the mutually meshing clutch parts at a very small transferred torque. If the friction force acting between the clutch parts falls below the force generated by the compression spring, the axially movable clutch part is urged away from the axially fixed clutch part, whereby an independent disengagement of the clutch device is effected. In other words, the named compression spring compensates the friction force acting between the clutch parts to achieve an independent disengagement of the clutch device at a point in time at which the transferred torque falls below a specific threshold value. The disengagement is abruptly initiated from this point in time onward.

Since, however, the friction force to be overcome depends not only on the torque transferred via the clutch, but also, among other things, on the dimension and design of the clutch parts, a compression spring having suitable properties must be provided for each variant of the clutch device so that an independent disengagement can take place in the desired manner. Wear phenomena at the components of the clutch device moreover result in a displacement of the threshold value at which the independent disengagement is initiated. This displacement can only be compensated by the expensive replacement of the affected components.

It is furthermore disadvantageous in the above-described construction that the axially moved clutch part is suddenly accelerated without hindrance on a removal of the friction force—i.e. at the point in time of the disengagement process at which the form fit between the clutch parts is canceled. This results in an increased wear of the involved components and thus in a reduced service life of the clutch device. In addition, disturbing switching noises occur.

A further disadvantageous effect which can be observed in known clutch devices is so-called gear hunting. It can occur if comparatively large fluctuations of the torque transmitted by the clutch device take place during the disengagement process, e.g. with “stick-slip” effects at the tires and a fast switching off of an actuator unit engaging the clutch parts. This results in a rapid sequence of unwanted engagement procedures and disengagement procedures which have the consequence of a reduced traction of a powertrain of a vehicle including the clutch device and a high strain on the clutch device.

It must further be taken into account that dangerous blockages can occur due to icing with a pneumatically actuated clutch device. If namely the compressed air acting on an actuator of the clutch device is abruptly released to disengage the clutch device, the compressed air escapes into the environment under very fast expansion. In this respect, a cooling occurs which can result in a freezing of moisture traces in the region of the actuator, in particular in the region of a pressure reduction line of the actuator. In an extreme case, the actuator and/or the pressure reduction line are blocked by the icing so that the clutch device can no longer be properly operated.

It is therefore an object of the present invention to provide a flexibly usable clutch device of the above-named kind which ensures a reliable and gentle disengagement of the clutch parts.

This object is satisfied by a clutch device for a powertrain of a motor vehicle having a first clutch part and a second clutch part which can be selectively brought into engagement with one another with form fitting and having a control device which includes a disengagement unit and an actuator unit operable by means of a fluid pressure, wherein a force which disengages the clutch parts can be generated by the disengagement unit and a force engaging the clutch parts can be generated by the actuator unit, and wherein a pressure holding device is associated with the control device to reduce a fluid pressure acting on the actuator unit in accordance with a predefined characteristic.

The coupling device has a first clutch part and a second clutch part which can be selectively brought into engagement with one another with form fitting. A control device is furthermore provided which includes a disengagement unit and an actuator unit operable by means of a fluid pressure. A force disengaging the clutch parts can be generated by the disengagement unit, whereas a force engaging the clutch parts can be generated by the actuator unit.

In accordance with the invention, a pressure holding device is associated with the control device to reduce a fluid pressure acting on the actuator unit in accordance with a predefined characteristic. Provision is therefore not made to allow the engaging force to drop abruptly to zero to effect a disengagement of the clutch device, but the reduction of the engaging force is rather influenced by the pressure holding device. The disengagement procedure is, for example, made more gentle by a delayed pressure reduction, whereby the involved components are loaded less without the dynamics of the clutch device suffering to a relevant degree. Gear hunting can also be efficiently prevented since the pressure reduction in the actuator unit can take place in accordance with a suitable time constant. Furthermore, a modification of the pressure holding device allows an adaptation of its pressure reduction characteristic, whereby the coupling device can be adjusted, for example, to compensate wear phenomena or to take changed demands on the switching dynamics of the clutch device into account. The pressure holding device can thus also be called a pressure reduction control device.

In other words, the operation of the above-described clutch device is based on a deliberate influencing of a force balance between the engaging and disengaging forces with the aid of the pressure holding device. A disengagement of the clutch device occurs when the force provided by the disengaging unit exceeds the sum of the forces preventing the disengagement—namely of the friction force and of the engagement force generated by the actuator unit. A predefined characteristic of the reduction of the fluid pressure acting on the actuator unit allows a better control of this force balance and thus of the disengagement procedure so that the latter is not dominated by fluctuations of the torque transferred by the clutch device during the disengagement and thus by the friction force acting between the clutch parts. A premature disengagement of the clutch device—and thus ultimately the occurrence of gear hunting—is in particular prevented.

The working fluid used for acting on the actuator unit can be air (pneumatic operation of the actuator unit) or a liquid, in particular oil (hydraulic operation of the actuator unit). The fluid pressure in the actuator can be generated, for example, by a connected pressure store or by a pump. In the last-named case, it is preferred if the pump is not driven in dependence on a speed of rotation difference between the two clutch parts, but is rather driven independently thereof. Otherwise, the engagement of the clutch parts cooperating in a form fitting manner takes place too slowly or it no longer possible at all due to the speed of rotation difference which has already built up.

It is sufficient and preferred if the named pressure holding device only acts on the working fluid of the actuator unit. The named pressure holding device hereby differs, for example, from restrictor valves or check valves which serve for venting a pressure space in known clutches with liquid working fluid.

In accordance with an advantageous embodiment, the pressure holding device includes a restrictor device with which the fluid pressure acting on the actuator unit can be reduced in a restricted and predefined manner. Due to the restricted reduction of the fluid pressure, the clutch unit is still reliably held closed for a predefined time period after a deactivation of the actuator unit up to the reaching of the above-described force balance. Gear hunting can thereby be prevented, for example, in situations in which the friction force acting between the clutch parts due to torque fluctuations drops very rapidly to small values after a switching off of the actuator unit and subsequently considerably rises again.

Since the restrictor device serves, as explained, for delaying the disengagement of the clutch parts, it is not necessary that the restrictor device has a temperature-dependent or temperature-compensating restriction characteristic. So that the restrictor device has an advantageously simple design, it is preferred if the restrictor device does not have any temperature-dependent or temperature-compensating restriction characteristic.

Alternatively or additionally to the restrictor device, it is possible that the pressure holding device includes a pressure holding valve with which a minimal fluid pressure acting on the actuator unit, i.e. a predefined holding pressure, is maintained. In other words, a fluid pressure acting on the actuator unit can only be reduced by means of the pressure holding valve up to a predefined minimal fluid pressure. The minimal fluid pressure defines up to when a force balance between the disengaging force of the disengagement unit, on the one hand, and the axial friction force as well as the engaging force generated by the actuator unit, on the other hand, is still present in the engaged state of the clutch device. The minimal fluid pressure predefinable by means of the pressure holding valve as result determines (in the case of the additional presence of the aforesaid restrictor device at the latest after the restricted reduction of the fluid pressure) which transferred torque has to be fallen below so that the disengagement unit moves the clutch parts away from one another. The switching point of the automatic disengagement of the clutch device can thus be influenced by the choice of a suitable minimal fluid pressure without the disengagement unit (e.g. compression spring) having to be replaced for this purpose.

The ensuring of a minimal fluid pressure can also be utilized as a pneumatic or hydraulic “stop” for the actuator unit. The position of rest of the axially movable clutch part can consequently be defined in the disengaged state by the choice of the minimal fluid pressure and the clutch device can thus be adjusted and adapted to changed conditions. The clearing distance to be overcome on the engaging of the clutch device can in particular be minimized by the choice of a suitable position of rest of the axially movable clutch part and the switching dynamics of the clutch device can thus be optimized.

A further advantage of a pressure holding valve, in particular with pneumatic actuator units, is that the minimal pressure of the compressed air acting on the actuator unit can be selected so that it is above the environmental pressure. A penetration of moisture into the actuator unit is therefore not possible and the risk of icing is eliminated.

The named minimal fluid pressure acting on the actuator unit is preferably smaller than the fluid pressure provided for the engagement of the clutch parts. A reliable disengagement of the clutch device is thereby ensured, while it is simultaneously prevented that the fluid pressure acting on the actuator unit is completely reduced.

The disengaging force of the disengagement unit is preferably smaller in amount after switching off the actuator unit with still engaged clutch parts and with a very small transferred torque to the clutch parts (namely during the restricted pressure reduction) than or is substantially equal to (namely after reaching the named minimal fluid pressure) the sum of the axial friction force between the clutch parts and the engaging force of the actuator unit caused by the instantaneous fluid pressure. The clutch parts thus disengage independently when the disengaging force exceeds the sum of the axial friction force and of the engaging force of the actuator. It is thereby ensured that no premature cancellation of the form fit between the clutch parts takes place.

If the restrictor device and/or the pressure holding valve are variably adjustable, the predefined characteristic of the pressure reduction can be modified in a simple manner in order, for example, to compensate wear of the clutch parts, of the disengagement unit or of other components of the clutch device or to adjust the switching dynamics of the clutch device. The restrictor device and/or the pressure holding valve can generally be actively adjustable in order, for example, to allow a fast intervention in the properties of the clutch device in specific situations. It is, however, preferred if the restrictor device and/or the pressure holding valve are passive components.

Provision can furthermore be made that the pressure holding device is arranged in a pressure reduction line which is in communication with the actuator unit and by which the fluid pressure acting on the actuator unit can be reduced. The pressure reduction line can be selectively blockable by a blocking valve. The blocking valve can be designed as a solenoid valve, for example.

A blocking of the pressure reduction line is in particular provided on a reduction of the fluid pressure, that is when fluid is supplied to the actuator unit via a pressure reduction line to engage the clutch parts. The blocking valve can furthermore serve to substantially maintain (i.e. apart from unavoidable leak losses) the fluid pressure in the actuator unit to keep the clutch parts reliably engaged—as long as the pressure reduction line is blocked. The disengagement of the clutch parts, in contrast, is triggered due to the effect of the disengagement unit by opening the blocking valve, i.e. by releasing the pressure reduction line, with the named restrictor device being able to effect the explained time delay of the disengagement of the clutch parts.

With a particularly simple design of the actuator unit, namely with a single blocking valve and a single connection line between the blocking valve and the pressure space of the actuator unit, the pressure holding device, in particular the named pressure holding valve, unlike a typical excess pressure valve, is preferably arranged at a side of the blocking valve remote from the actuator unit, i.e. downstream of the blocking valve with respect to the flow direction on a pressure reduction. It can thus be prevented by closing the blocking valve that the pressure holding device counters a desired build-up of the fluid pressure for engaging the clutch parts. If, in contrast, in addition to the pressure reduction line with a blocking valve, a separate pressure build-up line with its own blocking valve is provided, with both lines being connected to the pressure space of the actuator unit, the pressure holding device can generally be arranged at any desired point along the pressure reduction line.

The actuator unit can be operable hydraulically or pneumatically.

The named pressure reduction line can in particular be in communication with the environmental air with a pneumatically operated actuator unit. With a hydraulically operated actuator unit, the named pressure reduction line can open into a sump for the fluid.

A compact manner of construction can be achieved if the restrictor device, the pressure holding valve and/or the blocking valve are combined to one construction unit.

The named pressure reduction line preferably forms a main connection path which leads from the actuator unit (e.g. from a pressure space for a piston) to the environment of the clutch device (on use of compressed air) or to a sump (on use of a liquid working fluid). In other words, the pressure holding device should not act in a secondary connection path for the fluid (e.g. feedback path), but rather in a direct connection between the actuator unit and the fluid receiver (environmental air or sump). It is hereby achieved that the desired pressure holding effect is achieved reliably and reproducibly to reduce the fluid pressure in accordance with the predefined characteristic.

In particular a single pressure reduction line can be provided via which the fluid pressure acting on the actuator unit can be reduced, with the pressure holding device being arranged or operative in this single pressure reduction line.

It is furthermore preferred if the named pressure holding device is only arranged or operative in the pressure reduction line, but not in a pressure build-up line (i.e. fluid supply line) by which the fluid pressure in the actuator unit is built up. In other words, the pressure holding device should not impede the supply of the working fluid to the actuator unit (e.g. pressure space for a piston) so that an engaging of the clutch parts is not delayed. It is important with a clutch device operative in a form fitting manner that the engagement takes place fast before the speed of rotation difference becomes too large.

A design of the disengagement unit which is simple in construction and nevertheless efficient includes a compression spring which pretensions the clutch parts in the disengagement direction.

The invention also relates to a clutch device for a powertrain of a motor vehicle having a first clutch part and a second clutch part which can be selectively brought into engagement with one another with form fitting; having a compression spring which pretensions the first clutch part and the second clutch part in a disengagement direction; having an actuator unit which is operable by means of a fluid pressure to engage the first clutch part and the second clutch part against the disengagement direction; having a pressure reduction line which leads from the actuator unit to a fluid receiver and is provided for reducing a fluid pressure built up in the actuator unit; and having a pressure holding device which is operative in the pressure reduction line to reduce the fluid pressure built up in the actuator unit in accordance with a predefined characteristic. The above-explained embodiments and further developments can also be transferred to such a coupling device.

The invention further relates to a method of controlling a clutch device having clutch parts which cooperate with form fitting and which can be selectively brought into engagement with one another. The coupling device has a control device which includes a disengagement unit and an actuator unit operable by means of a fluid pressure. A force disengaging the clutch parts can be generated by the disengagement unit, whereas a force engaging the clutch parts can be generated by the actuator unit. The fluid pressure acting on the actuator unit is reduced via a pressure holding apparatus in accordance with a predefined characteristic for disengaging the clutch parts. The fluid pressure is in particular reduced in a restricted manner. Alternatively or additionally to a restricted pressure reduction, provision can be made that the fluid pressure acting on the actuator unit is only reduced so far that a minimal pressure level (i.e. the aforesaid minimal fluid pressure) is not fallen below.

Further embodiments of the invention are set forth in the description, in the claims and in the enclosed drawings.

Advantageous embodiments of the present invention will be described in the following purely by way of example with reference to the enclosed drawings. There are shown:

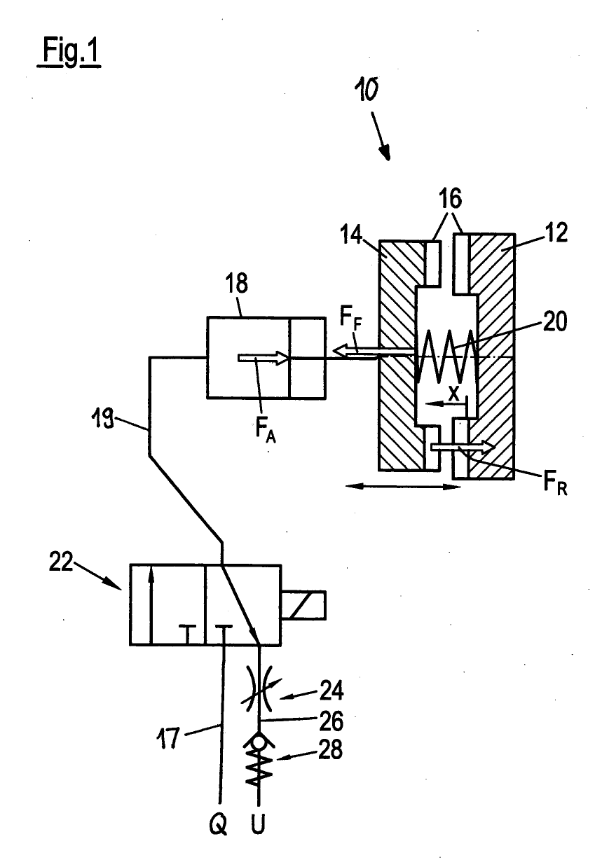

FIG. 1 a schematic drawing of an embodiment of the clutch device in accordance with the invention;

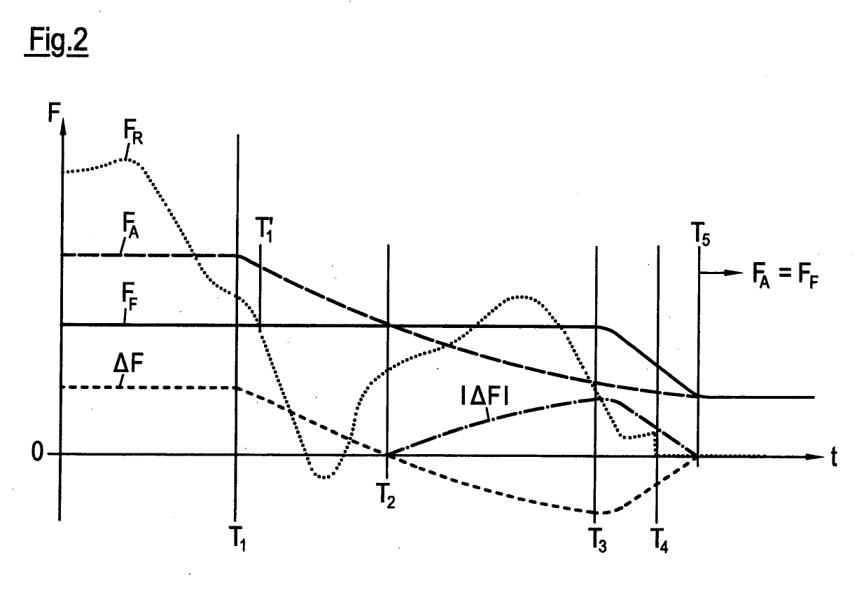

FIG. 2 a diagram for illustrating the time development of the forces occurring during a disengagement procedure in the clutch device.

FIG. 1 shows a clutch device 10 which includes an axially fixed clutch part 12 and an axially movable clutch part 14. The clutch parts 12, 14 have dogs 16 which are designed complementary to one another and which can be brought into engagement with one another with form fitting to transfer a torque between the clutch parts 12, 14. Reference is made to the initially named document EP 0 510 457 A1 with respect to the basic operation of such a clutch device.

A series of forces act on the axially movable clutch part 41 to be able to move it selectively in the axial direction (marked symbolically by a double arrow beneath the clutch part 14). On the one hand, an actuator force F_{A} generated by an actuator 18 acts on the clutch part 14 in the engagement direction. In the present example, the actuator 18 is pneumatically operated so that the actuator force F_{A} is a function of a pressure p supplied to it. For this purpose, compressed air is supplied to the actuator 18 from a compressed air source Q via a pressure build-up line 17 and via a connection line 19 to increase the pressure p in a pressure space of the actuator 18.

On the other hand, a spring force F_{F} which is generated by a compression spring 20 and which thus counters an engagement of the clutch parts 12, 14, acts on the clutch part 14 in the disengagement direction. In other words, the clutch parts 12, 14 are pretensioned in the disengagement direction by the compression spring 20. The spring force F_{F} is a function of a spacing x of the clutch parts 12, 14 (in accordance with the spring deflection). In a state x=0, the clutch device 10 is completely engaged.

In addition to the forces F_{A}, F_{F}, a friction force acts with an axial component F_{R} (with respect to the axis of rotation of the clutch device 10) on the axially movable clutch part 14 as soon as the dogs 16 of the clutch parts 12, 14 come into engagement and a torque is transferred via the clutch parts 12, 14. The friction force F_{R}, like the actuator force F_{A} counters a disengagement and depends among other things on the torque transferred between the clutch parts 12, 14, on the design of the flanks 16 and on their quality. The friction force F_{R} can also include other friction forces, in addition to the friction at the dogs 16 of the clutch parts 12, 14, which counter the movement of the axially movable clutch part 14.

The force balance defining a movement of the clutch part 14 can be formulated as follows in general form:

F_{F}(x)=F_{A}(p)+F_{R}(x, M).

where M equals the amount of the torque transferred by the clutch device. The greater the torque M, the more the dogs 16 of the clutch parts 12, 14 cooperate, which results in a higher axial friction force F_{R}.

In an engaged state, the spring force F_{F} is smaller than the sum of the actuator force F_{A} and of the friction force F_{R}. To effect a disengagement, one of the two force F_{A}, F_{R}—or both—can now be lowered until the sum of the forces F_{A}, F_{R} falls below the spring force F_{F} and the clutch device 10 disengages independently. On a falling below of F_{F}, the spring 20 namely provides that the axially movable clutch part 14 moves away from the axially fixedly arranged clutch part 12 until the dogs 16 are no longer in engagement.

A lowering of the friction force F_{R} takes place, for example, when the transferred torque M reduces. The disengagement procedure of the clutch device 10 starts when the friction force F_{R} falls below a specific threshold at a given actuator force F_{A} so that F_{F}>F_{A}+F_{R}.

Alternatively or simultaneously, the actuator force F_{A} can be lowered until F_{F}>F_{A}+F_{R}. For this purpose, the pressure p of the pressure fluid acting on the actuator 18—compressed air here, for example—is reduced. A solenoid valve 22 is opened for this purpose, i.e. is brought into the position shown in FIG. 1 so that the compressed air can be output to the environment U (atmosphere). For this purpose, the solenoid valve 22 is designed as a 3/2 way valve and it is arranged between the actuator 18 and the connection line 19, on the one hand, and the compressed air source Q and the environment U, on the other hand.

A disengagement of the clutch device 10 is therefore triggered by opening the solenoid valve 22, with the disengagement procedure actually only starting when the aforesaid condition F_{F}>F_{A}+F_{R} is satisfied.

To prevent the pressure reduction in the actuator 18 from taking place abruptly and an uncontrolled disengagement of the clutch device 10 thereby taking place, a restrictor 24 is arranged in a pressure reduction line 26 which connects the actuator 18 via the solenoid valve 22 to the environment U. When the solenoid valve 22 is opened, the pressure p acting on the actuator 18 is reduced in a restricted manner to ensure a controlled disengagement procedure. An acceleration of the clutch part 14 is in particular also suppressed which occurs in conventional clutch devices as soon as the dogs 16 move out of engagement from a specific point in the disengagement procedure onward and the friction force F_{R} thus abruptly falls to zero. The restricted reduction of the fluid pressure p in accordance with a predefined characteristic which is defined by the design of the restrictor 24 is furthermore in particular of advantage when comparatively large fluctuations of the transferred torque M are present during the disengagement process since gear hunting is avoided by the prevention of a premature disengagement of the clutch parts 12, 14.

The restriction effect of the restrictor 24 can be adjustable actively or passively to be able to adapt the disengagement dynamics of the clutch device 10 according to demand.

In addition to the restrictor 24, a pressure holding valve 28 is provided in the pressure reduction line 26 whose object is to ensure that a predefined minimal pressure level pₘᵢₙ always acts on the actuator 18, i.e. is maintained in the pressure chamber of the actuator 18. The actuator 18 acts as a type of “stop” due to the minimal pressure level pₘᵢₙ. When the clutch device 10 is disengaged, a force is no longer applied to the clutch part 14 at F_{F}=F_{A}(pₘᵢₙ) and consequently a balance state is reached in which the axially movably clutch part 14 adopts a position of rest.

In other words, the pressure holding valve 28 is a check valve which maintains a predefined excess pressure pₘᵢₙ at its upstream side. It is also thereby prevented that environmental air penetrates into the pneumatic system and there results in icing on a pressure reduction of the compressed air during a disengagement procedure. In addition, a further engagement of the clutch device 10 can thus be initiated more rapidly since only a relatively small pressure reduction is required in the actuator 18 in comparison with a completely emptied pressure space. The named minimal pressure pₘᵢₙ, which forms the switching threshold for the pressure holding valve 28, is (unlike with a conventional excess pressure valve) smaller than the pressure p used in operation of the clutch device 10 for engaging the clutch parts 12, 14. After the restricted pressure reduction to the aforesaid minimal pressure level pₘᵢₙ, the aforesaid disengagement condition F_{F}>F_{A}+F_{R} thus relates to the actuator force F_{A}(pₘᵢₙ) still remaining at pₘᵢₙ.

It is understood that the pressure holding valve 28 can be set actively or passively to be able to variably set the predefined minimal pressure pₘᵢₙ and thus to be able to influence the properties of the clutch device 10.

Provision can be made with specific embodiments to dispense either with the restrictor 24 or the pressure holding valve 28. The order of the components 24 and 28 is arbitrary; however, in the embodiment shown in FIG. 1 in which the connection line 19 serves both for the compressed air supply and the for the pressure reduction, they are only arranged in the pressure reduction line 26 on the side of the solenoid valve 22 remote from the actuator 18. The restrictor 24 and the pressure holding valve 28 can also be integrated into one component. Furthermore, the restrictor 24 and/or the pressure holding valve 28 can be integrated into the solenoid valve 22.

FIG. 2 shows the time development of the relevant forces acting in the clutch device 10 during a disengagement procedure.

FIG. 2 shows by way of example a development of the friction force F_{R} which varies on the basis of torque fluctuations in a powertrain. The actuator force F_{A} acts in the same direction—that is in an engaging manner. In the opposite-direction, the spring force F_{F} is active. The difference between the actuator force F_{A} and the spring force F_{F} is shown by the development of ΔF (difference force).

The forces F_{A}, F_{F} are constant before the start of the disengagement process, whereas the friction force F_{R} fluctuates in time. At the point in time T₁, the solenoid valve 22 of the clutch device 10 of FIG. 1 is opened to reduce the pressure p acting on the actuator 18 and thus to effect a disengagement of the clutch device 10. In contrast to systems of a conventional type, the disengagement process does not start at the point in time T₁′ when the forces F_{F}, F_{R} are equal in amount for the first time after the point in time T₁. Due to the restricted pressure reduction, the actuator force F_{A} namely initially drops more slowly, which is also reflected in the development of the difference force ΔF. Only from the point in time T₂ onward at which the difference force ΔF=F_{A}−F_{F}=0 and is then negative (F_{A}<F_{F}) can a disengagement take place. Due to the fluctuations of the friction force F_{R} as a result of a time-wise variable torque transfer, however, the sum of the forces F_{A}, F_{R} acting in an engaging manner still predominates so that a disengagement of the clutch device 10 still does not take place in the example shown.

From the point in time T₂ onward, in addition to the difference force ΔF which is becoming negative (i.e. the spring force F_{F} is larger from this point in time onward than the actuator force F_{A}), the amount of the difference force |ΔF| is also shown. As soon as the amount of the difference force |ΔF| becomes larger than the friction force F_{R}, the disengagement procedure starts, here at the point in time T₃. Due to the disengagement procedure, a reduction in the spring force F_{F} and a change in the friction force F_{R} is effected on the basis of the increasing distance x between the clutch parts 12, 14, with the latter having torque fluctuations superimposed on it.

From the point in time T₄, the dogs 16 of the clutch parts 12, 14 are no longer in contact so that the friction force F_{R} drops abruptly. The moving clutch part 14 is pressed further away from the axially fixed clutch part 12 by the action of the spring force F_{F}. The spring force F_{F} drops due to the increase in the spacing x. At the same time, the actuator force F_{A} drops until it reaches a value defined by the predefined minimal pressure pₘᵢₙ. As soon as a force balance is adopted between the forces F_{A} and F_{F}—i.e. as soon as the difference force ΔF again adopts the value zero—a balance state is reached which is marked by the point in time T₅ in the diagram of FIG. 2. The clutch part 14 is now located in a disengaged position of rest.

It can be seen from the above explanations that the behavior of the clutch device 10 can be influenced in a simple manner by a suitable choice of the restriction effect of the restrictor 24 and a choice of the minimal pressure pₘᵢₙ. Gear hunting which damages the clutch device 10 can be prevented in an efficient manner, which results in a reduced wear of all involved components. The noise development on a disengagement procedure is also reduced since a “pneumatic stop” is realized and a mechanical stop can be omitted. An adaptation of the restrictor 24 and of the pressure holding valve 28 makes it possible to use the clutch device 10 in different areas of application without construction modifications being necessary. An individual adaptation of the spring force by providing a corresponding spring for the respective application is in particular not necessary, but can rather be achieved by a suitable adjustment of the restrictor 24 and of the pressure holding valve 28.

1. A clutch device for a powertrain of a motor vehicle having a first clutch part (12) and a second clutch part (14) which can selectively be brought into form fitting engagement with one another and having a control device which includes a disengagement unit (20) and an actuator unit (18) operable by means of a fluid pressure,
wherein a force (F_{F}) disengaging the clutch parts (12, 14) can be generated by the disengagement unit (20) and a force (F_{A}) engaging the clutch parts can be generated by the actuator nit (18), and wherein a pressure holding device (24, 28) is associated with the control device to reduce a fluid pressure acting on the actuator unit (18) in accordance with a predefined characteristic.

2. A clutch device in accordance with claim 1,
wherein the pressure holding device includes a restrictor device (24) with which the fluid pressure acting on the actuator unit (18) can be reduced in a restricted manner.

3. A clutch device in accordance with claim 1,
wherein the pressure holding device includes a pressure holding valve (28) with which a minimal fluid pressure acting on the actuator unit (18) can be maintained.

4. A clutch device in accordance with claim 3,
wherein the fluid pressure acting on the actuator unit (18) is smaller than the fluid pressure (p) provided for engaging the clutch parts (12, 14).

5. A clutch device in accordance with claim 1,
wherein the pressure holding device includes a restrictor device (24) with which the fluid pressure acting on the actuator unit (18) can be reduced in a restricted manner and includes a pressure holding valve (28) with which a minimal fluid pressure acting on the actuator unit (18) can be maintained.

6. A clutch device in accordance with claim 1,
wherein, after switching off the actuator unit (18) with engaged clutch parts (12, 14) and with a very small transferred torque to the clutch parts (12, 14), the disengaging force (F_{F}) of the disengagement unit (20) is smaller in amount than or substantially equal to the sum of the axial friction force (F_{R}) between the clutch parts (12, 14) and the engaging force (F_{A}) of the actuator unit (18) caused by the fluid pressure, wherein the clutch parts (12, 14) disengage independently, when the disengaging force (F_{F}) exceeds the sum of the axial friction force (F_{R}) and of the engaging force (F_{A}).

7. A clutch device in accordance with claim 1,
wherein the pressure holding device (24, 28) is variably adjustable.

8. A clutch device in accordance with claim 1,
wherein the pressure holding device (24, 28) is a passive component.

9. A clutch device in accordance with claim 1,
wherein the pressure holding device (24, 28) is arranged or operative in a pressure reduction line (26) which is in communication with the actuator unit (18) and by which the fluid pressure acting on the actuator unit (18) can be reduced.

10. A clutch device in accordance with claim 9,
wherein the pressure reduction line (26) can be selectively blocked by a blocking valve (22).

11. A clutch device in accordance with claim 10,
wherein the pressure holding device (24, 28) is arranged at a side of the blocking valve (22) remote from the actuator unit (18).

12. A clutch device in accordance with claim 10,
wherein at least one part of the pressure holding device (24, 28) and the blocking valve (22) together form an assembly.

13. A clutch device in accordance with claim 9,
wherein the pressure reduction line (26) forms a main communication path which leads from the actuator unit (18) to a fluid receiver (U) of the clutch device.

14. A clutch device in accordance with claim 9,
wherein the clutch device furthermore includes a pressure reduction line (17) by which the fluid pressure acting on the actuator unit (18) can be reduced, with the pressure holding device (24, 28) only being arranged or operative in the pressure reduction line (26), but not in the pressure build-up line.

15. A clutch device in accordance with claim 1,
wherein the disengagement unit includes a compression spring (20).

16. A clutch device in accordance with claim 1,
wherein the actuator unit (18) is hydraulically or pneumatically operable.

17. A clutch device for a powertrain of a motor vehicle having:
a first clutch part (12) and a second clutch part (14) which can be selectively brought into engagement with one another with form fitting;
a compression spring (20) which pretensions the first clutch part and the second clutch part in a disengagement direction;
an actuator unit (18) which is operable by means of a fluid pressure to engage the first clutch part and the second clutch part against the disengagement direction;
a pressure reduction line (26) which leads from the actuator unit to a fluid receiver (U) and is provided for reducing a fluid pressure built up in the actuator unit; and
a pressure holding device (24, 28) which is operative in the pressure reduction line to reduce the fluid pressure built up in the actuator unit in accordance with a predefined characteristic.

18. A clutch device in accordance with claim 17,
wherein the pressure holding device includes a restrictor device with which the fluid pressure acting on the actuator unit (18) can be reduced in a restricted manner.

19. A clutch device in accordance with claim 17,
wherein the pressure holding device includes a restrictor device (24) with which the fluid pressure acting on the actuator unit (18) can be reduced in a restricted manner and includes a pressure holding valve 28) with which a minimal fluid pressure acting on the actuator unit (18) can be maintained.

20. A method of controlling a clutch device having coupling parts (12, 14) which cooperate in a form fitting manner and which can be selectively brought into engagement with one another and having a control device which includes a disengagement unit (20) and an actuator unit (18) operable by means of a fluid pressure, wherein a force (F_{F}) disengaging the clutch parts (12, 14) is generated by the disengagement unit (20) and a force (F_{A}) engaging the clutch parts (12, 14) is generated by the actuator unit (18),
wherein the fluid pressure acting on the actuator unit (18) is reduced by means of a pressure holding apparatus (24, 28) in accordance with a predefined characteristic.

21. A method in accordance with claim 20,
wherein the fluid pressure acting on the actuator unit (18) is reduced in a restricted manner by means of the pressure holding apparatus (24, 28).

22. A method in accordance with claim 20,
wherein the fluid pressure acting on the actuator unit (18) is only reduced so far by means of the pressure holding apparatus (24, 28) that a minimal pressure level is not fallen below.

23. A method in accordance with claim 20,
wherein the fluid pressure acting on the actuator unit (18) is reduced in a restricted manner by means of the pressure holding apparatus (24, 28) and is only reduced so far that a minimal pressure level is not fallen below.
